(19) United States
(12) Patent Application Publication
(10) Pub. No.: US 2024/0247763 A1
(43) Pub. Date: Jul. 25, 2024

(54) TANK MOUNTING STRUCTURE

(71) Applicant: TOYOTA JIDOSHA KABUSHIKI KAISHA, Toyota-shi (JP)

(72) Inventors: Shinnosuke SAKO, Toyota-shi (JP); Tomoyoshi KOBAYASHI, Toyota-shi (JP)

(73) Assignee: TOYOTA JIDOSHA KABUSHIKI KAISHA, Toyota-shi (JP)

(21) Appl. No.: 18/392,031

(22) Filed: Dec. 21, 2023

(30) Foreign Application Priority Data
Jan. 24, 2023 (JP) 2023-008563

(51) Int. Cl. F17C 13/08

(52) U.S. Cl. CPC F17C 13/08; F17C 2201/035; F17C 2205/0107; F17C 2205/013

(57) ABSTRACT

The tank mounting structure includes a plurality of tanks, a frame on which the plurality of tanks are mounted in a state of being aligned in the width direction, and a plurality of mounting structures that are fixed to both end portions of the frame in the axial direction and support each tank. The tank has a first neck arranged on one side in the axial direction and a second neck arranged on the other side. The first neck is fixed to the frame via the first mounting structure. The second neck is supported by the frame via a second mounting structure and is movable in the axial direction by expansion or contraction of the tank. The first necks of adjacent tanks are alternately fixed to the end portions of the frame in the axial direction.

### CROSS-REFERENCE TO RELATED APPLICATION

This application claims priority to Japanese Patent Application No. 2023-008563 filed on Jan. 24, 2023, incorporated herein by reference in its entirety.

### BACKGROUND

### 1. Technical Field

The present application relates to a tank mounting structure.

### 2. Description of Related Art

A tank filled with high-pressure hydrogen gas or the like is mounted on a predetermined frame and transported. A tank fixing structure using a neck mount disclosed in Japanese Unexamined Patent Application Publication No. 2017-206042 (JP 2017-206042 A), for example, is known as a tank fixing structure in a frame.

### SUMMARY

Tanks are known to expand and contract as gas is filled therein and discharged therefrom. When fixing a tank to a frame, one end portion (fixed end) of the tank in an axial direction is usually fixed to the frame, and the other end portion (sliding end) thereof is supported by the frame so as to be movable as the tank expands and contracts. Thus, gas can be filled to and discharged from the tank in a state in which the tank remains fixed to the frame.

Now, a plurality of tanks is mounted on one frame. Normally, the tanks are disposed aligned in a width direction of the frame, and the fixed ends of the tanks are fixed biased to one side of the frame in the axial direction. Thus, the frame may be subjected to a concentrated load from the fixed ends due to expansion and contraction of the tanks during filling and discharging of gas, and there is a concern that the frame may become distorted.

Accordingly, a primary object of the present disclosure is to provide a tank mounting structure capable of suppressing distortion of the frame.

As one aspect of the present disclosure for solving the above problem, provided is a tank mounting structure that includes
a plurality of tanks,
a frame on which the tanks are mounted, in a state of being aligned in a width direction, and
a plurality of mounting structures, each of which is fixed to both end portions of the frame in an axial direction, and supports respective tanks.
Each tank includes a first neck disposed on one side in the axial direction and a second neck disposed on another side.
Each mount structure includes a first mount structure attached to the first neck and a second mount structure attached to the second neck.
The first neck is fixed to the frame via the mounting structure.
The second neck is supported by the frame via the mounting structure, and is movable in the axial direction under expansion or contraction of the tank.
The first necks of adjacent tanks are alternately fixed to opposite end portions of the frame in the axial direction.

In the above tank mounting structure, the first necks of all the tanks may be alternately fixed to opposite end portions of the frame in the axial direction. The mount structures may be neck mount structures.

According to the tank mounting structure of the present disclosure, distortion of the frame can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a tank mounting structure 100;

FIG. 2 is a side view of the tank mounting structure 100 viewed from direction II of FIG. 1;

FIG. 3 is a cross-sectional view of tank mounting structure 100 taken along line III-III of FIG. 1;

FIG. 4 is a schematic diagram showing how the tank 10 expands or contracts; and

FIG. 5 is a plan view of a conventional tank mounting structure 200.

### DETAILED DESCRIPTION OF EMBODIMENTS

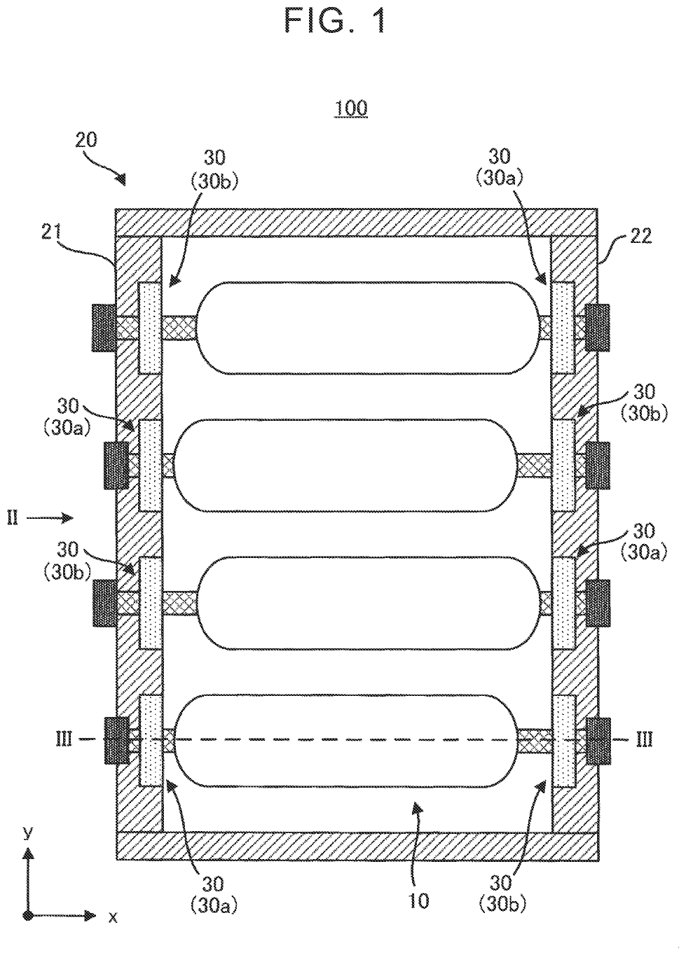

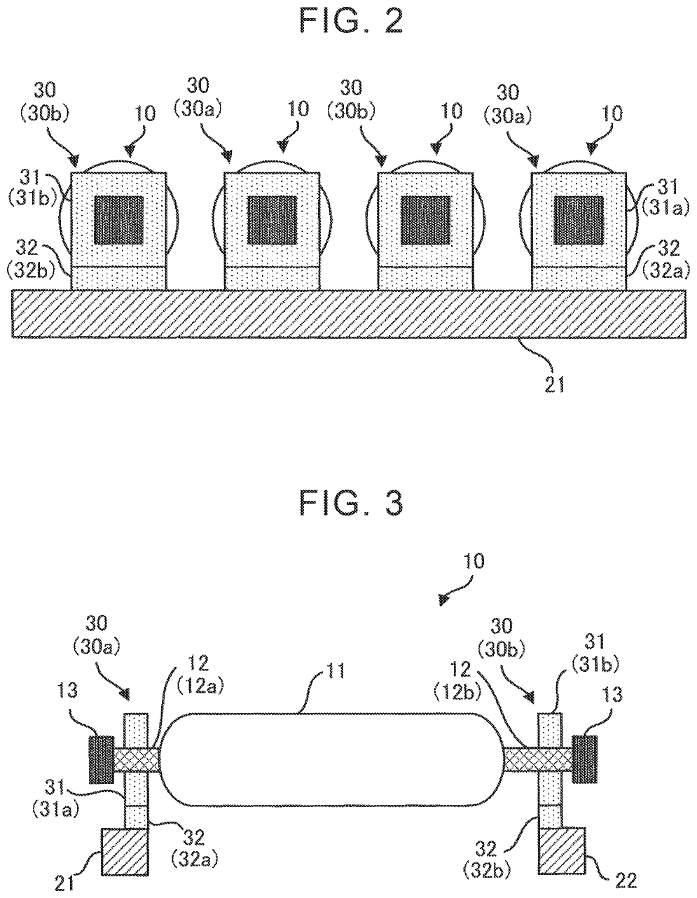

The tank mounting structure of the present disclosure will be described using a tank mounting structure 100, which is one embodiment. A plan view of a tank mounting structure 100 is shown in FIG. 1. FIG. 2 shows a side view of the tank mounting structure 100 viewed from direction II in FIG. 1. A cross-sectional view of the tank mounting structure 100 taken along line III-III of FIG. 1 is shown in FIG. 3. Here, the x direction in FIG. 1 is the width direction (the width direction of the tank), and the y direction is the axial direction (the central axis direction of the tank).

The tank mounting structure 100 includes a plurality of tanks 10, a frame 20 on which the plurality of tanks 10 are mounted in a state of being arranged in the width direction, and a plurality of tanks fixed to both end portions in the axial direction of the frame 20 to support the tanks and a mounting structure 30.

### Tank 10

The tank 10 is a high-pressure gas tank that can be filled with gas at high pressure. The type of gas is not particularly limited. Types of gas include, for example, fuel gas (hydrogen, reformed gas, etc.) used in fuel cell.

The tank 10 includes a tank body 11 having a hollow cylindrical shape, and necks 12 arranged at both end portions of the tank body 11 in the axial direction. A cylindrical trunk portion of the tank body 11 has the largest outer diameter and extends in the axial direction. The shoulder portion is a portion that connects the body portion and the neck 12, and is formed so that the outer diameter becomes smaller toward the outside in the axial direction. The neck 12 is a cylindrical member having an outer diameter smaller than that of the barrel. Here, the neck 12 arranged on one side in the axial direction is the first neck 12a, and the neck 12 arranged on the other side is the second neck 12b.

The neck 12 has a communication hole communicating with the inside of the tank 10. The opening of the communication hole is sealed by the lid portion 13. The tank 10 can be hermetically sealed by fixing the lid portion 13 to the neck 12. The lid portion 13 may be provided with a valve mechanism for filling and discharging gas. At least one of the lid portions 13 may be provided with the valve mechanism. Normally, a valve mechanism is provided on the lid portion 13 arranged on the first neck 12a. This is because the first neck 12a is fixed to the frame 20, as will be described later.

The tank 10 is manufactured, for example, as follows. First, the surface of a liner having a hollow cylindrical shape is covered with a fiber layer to form a tank intermediate. Next, the neck 12 is placed on the small-diameter end portion of the tank intermediate body, and the tank 10 is sealed with the lid portion 13. Thus, the tank 10 is produced. The liner is made of a resin material such as nylon. The fiber layer is made of fiber-reinforced resin such as carbon fiber. Generally, a fiber layer is formed by weaving a fiber bundle formed by bundling a plurality of fiber-reinforced resins on the surface of the liner. The fiber layer can be formed using, for example, a braiding method.

### Frame 20

The frame 20 is for mounting a plurality of tanks 10 in a row in the width direction. The frame 20 has a rectangular shape, and pillars are arranged on each side. Here, the columns arranged at both end portions in the axial direction are referred to as columns 21 and 22, respectively.

The frame 20 shown in FIG. 1 is simple, and the frame 20 used for the tank mounting structure 100 is not limited to this. For example, a vertically stackable frame may be used. Also, the number of tanks 10 on which the frame 20 can be mounted is not particularly limited. FIG. 1 shows a frame 20 on which four tanks 10 can be mounted.

### Mounting Structure 30

The mounting structure 30 is a member that is fixed to both end portions (columns 21 and 22) of the frame 20 in the axial direction and supports each tank 10. Specifically, the mounting structure 30 supports the neck 12 of the tank 10. As shown in FIGS. 2 and 3, the mounting structure 30 consists of a neck block 31 and a neck mount 32. That is, the mounting structure 30 is a neck mount structure. Since the detailed structure of the neck mount structure is well known, the explanation is omitted here. For example, Japanese Unexamined Patent Application Publication No. 2017-206042 can be referred to.

The neck block 31 is a member attached to the neck 12. Neck block 31 has a hole through which neck 12 passes. The neck mount 32 is a member that connects the neck block 31 and the frame 20. The neck block 31 and the neck mount 32 are fixed with screws or the like, for example. Also, the neck mount 32 and the frame 20 (columns 21, 22) are fixed with screws or the like, for example.

Here, the mounting structure 30 attached to the first neck 12a is referred to as a first mounting structure 30a, and the mounting structure 30 attached to the second neck 12b is referred to as a second mounting structure 30b. Accordingly, the mounting structure 30 has a first mounting structure 30a and a second mounting structure 30b. The first mounting structure 30a also has a first neck block 31a and a first neck mount 32a. The second mounting structure 30b has a second neck block 31b and a second neck mount 32b.

The first neck 12a is fixed to the frame 20 via the mounting structure 30a. Specifically, the first neck 12a and the first neck block 31a are fixed by screws or the like, for example. Thereby, the position of the first neck 12a is fixed, and movement of the first neck 12a is prohibited. That is, it can be said that the first neck 12a is a fixed end in the tank 10. On the other hand, the second neck 12b is only supported by the frame 20 via the second mounting structure 30b and is not fixed. Therefore, the second neck 12b is movable in the axial direction by expansion or contraction of the tank 10 through the hole in the second neck block 31b. That is, it can be said that the second neck 12b is a moving end (sliding end) in the tank 10.

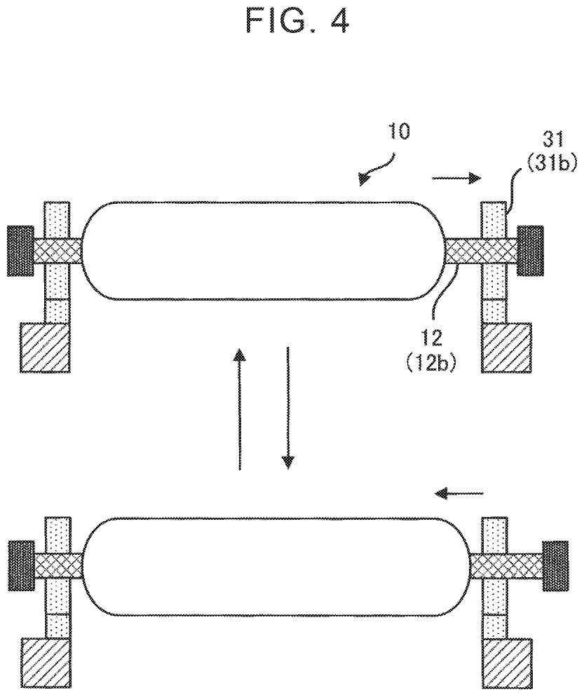

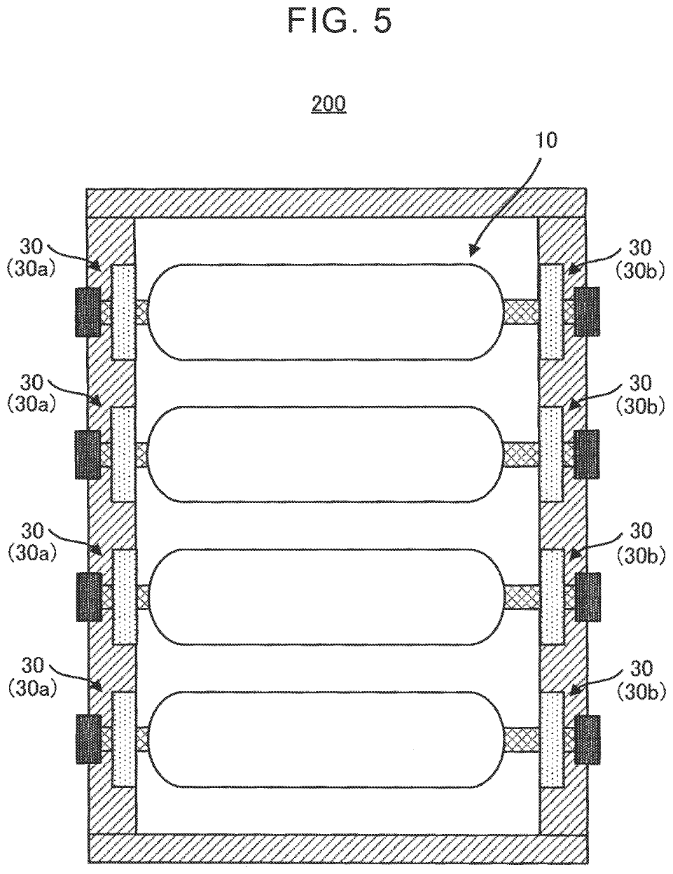

FIG. 4 is a schematic diagram showing how the tank 10 expands or contracts. The top view of FIG. 4 shows the tank 10 deflated. The bottom view of FIG. 4 shows the tank 10 inflated. As shown in FIG. 4, since the first neck 12a is fixed to the first neck block 31a, even if the tank 10 expands or contracts, its position does not move. On the other hand, since the second neck 12b is not fixed to the second neck block 31b, it can slide and move through the hole of the second neck block 31b as the tank 10 expands or contracts. In this way, by making one end of the tank 10 a fixed end and the other a sliding end, it is possible to expand or contract the tank 10 as gas is charged or discharged.

The second neck 12b may be formed longer in the axial direction than the first neck 12a. This is to ensure the movable range of the second neck 12b, as shown in FIG. 4.

### Tank Mounting Structure 100

As shown in FIG. 1, the tank mounting structure 100 has a plurality of tanks 10 aligned in the width direction and mounted on the frame 20. Here, when attention is paid to the orientation of the tanks 10, adjacent tanks 10 have opposite orientations in the axial direction. In other words, the first necks 12a of adjacent tanks 10 are alternately fixed to both end portions (columns 21, 22) of the frame 20 in the axial direction. In other words, at both end portions (columns 21 and 22) of frame 20, first mounting structures 30a and second mounting structures 30b are alternately arranged in the width direction. In the tank mounting structure 100, the first end portions 13a of all the tanks 10 are alternately fixed to both end portions (columns 21, 22) of the frame 20 in the axial direction. Distortion of the frame 20 can be suppressed by arranging the tank 10 in this way. The reason is explained below.

A plan view of a conventional tank mounting structure 200 is shown in FIG. 5. The tank mounting structure 100 and the conventional tank mounting structure 200 differ only in the arrangement of the tank 10. Therefore, each member of the tank mounting structure 200 uses the same reference numerals as those of the tank mounting structure 100.

As shown in FIG. 5, in the conventional tank mounting structure 200, all the tanks arranged have the same orientation. In other words, the first necks 12a of all the tanks 10 are fixed to one end portion (pillar 21) of the frame 20 in the axial direction via the mounting structure 30a. When the tank 10 is filled with gas, it expands, but as described above, since only the sliding end (second neck 12b) moves, the load due to the expansion is received by the fixed end. Specifically, the fixed portion between the first mounting structure 30a and the column 21 receives the load due to the expansion. Then, in the tank mounting structure 200, since the first necks 12a of all the tanks 10 are fixed to the same column 21, the load is concentrated on the column 21. Therefore, in the conventional tank mounting structure 200, there arises a problem that the frame 20 (in particular, the column 21) is distorted.

On the other hand, in the tank mounting structure 100, adjacent tanks 10 are staggered. As a result, the first neck 12a (or the mounting structure 30a), which is the fixed end, is evenly arranged on both the columns 21 and 22, so that the load due to the expansion of the tank 10 is distributed and applied to the columns 21 and 22. Therefore, according to the tank mounting structure 100, distortion of the frame 20 can be suppressed.

### Supplement

The tank mounting structure 100 used a neck mount structure as the preferred mounting structure 30. However, the type of mounting structure 30 is not limited to this. For example, a known structure that simply fixes the frame 20 and the first neck 12a may be used as the first mounting structure 30a. Also, a known structure using a damper and a spring may be used for the second mounting structure 30b.

As described above, the tank mounting structure of the present disclosure has been described using one embodiment. According to the tank mounting structure of the present disclosure, distortion of the frame can be suppressed.

What is claimed is:

1. A tank mounting structure, comprising:
a plurality of tanks;
a frame on which the tanks are mounted, in a state of being aligned in a width direction; and
a plurality of mounting structures, each of which is fixed to both end portions of the frame in an axial direction, and supports respective tanks, wherein
each tank includes a first neck disposed on one side in the axial direction and a second neck disposed on another side,
each mount structure includes a first mount structure attached to the first neck and a second mount structure attached to the second neck,
the first neck is fixed to the frame via the first mounting structure,
the second neck is supported by the frame via the second mounting structure, and is movable in the axial direction under expansion or contraction of the tank, and
the first necks of adjacent tanks are alternately fixed to opposite end portions of the frame in the axial direction.

2. The tank mounting structure according to claim 1, wherein the first necks of all the tanks are alternately fixed to opposite end portions of the frame in the axial direction.

3. The tank mounting structure according to claim 1, wherein the mount structures are neck mount structures.
